(19) United States
(12) Patent Application Publication
(10) Pub. No.: US 2006/0201130 A1
(43) Pub. Date: Sep. 14, 2006

(54) Articulating mechanisms with joint assembly and manual handle for remote manipulation of instruments and tools

(76) Inventor: David J. Danitz, San Jose, CA (US)

Correspondence Address: MORRISON & FOERSTER LLP, 755 PAGE MILL RD, PALO ALTO, CA, 94304-1018, US

(21) Appl. No.: 11/344,465

(22) Filed: Jan. 30, 2006

Related U.S. Application Data
(60) Provisional application No. 60/648,984, filed on Jan. 31, 2005.

(51) Int. Cl. F16G 13/00

(52) U.S. Cl. 59/78.1

(57) ABSTRACT

A surgical instrument having a distally located surgical or diagnostic tool, a plurality of links proximal of the surgical or diagnostic tool, with at least two or more adjacent links being moveable relative to one another; and a joint assembly proximal of the plurality of links, with the joint assembly connected to a manually moveable handle extending proximally of the joint assembly. The links are operably connected to the joint assembly by cables such that manual movement of the handle causes a corresponding movement of the two or more adjacent links.

### CROSS REFERENCE TO RELATED APPLICATIONS

This application claims priority to U.S. Provisional Patent Application Ser. No. 60/648,984, filed Jan. 31, 2005, which is hereby incorporated by reference in its entirety.

### FIELD OF THE INVENTION

This invention relates to link systems and applications thereof, including the remote guidance and manipulation of instruments and tools.

### BACKGROUND

The ability to easily remotely steer, guide and/or manipulate instruments and tools is of interest in a wide variety of industries and applications, in particular where it is desired to navigate an instrument or tool into a workspace that is not easy to manually navigate by hand or that might otherwise present a risk or danger. These can include situations where the targeted site for the application of a tool or instrument is difficult to access, e.g., certain surgical procedures, the manufacture or repair of machinery, or even commercial and household uses, where manual access to a targeted site is restricted or otherwise. Other situations can include e.g., industrial applications where the work environment is dangerous to the user, such as workspaces exposed to dangerous chemicals. Still other situations can include e.g., law enforcement or military applications where the user may be at risk, such as deployment of a tool or instrument into a dangerous or hostile location.

Using surgical procedures as an illustrative example, procedures such as endoscopy and laparoscopy typically employ instruments that are steered within or towards a target organ or tissue from a position outside the body. Examples of endoscopic procedures include sigmoidoscopy, colonoscopy, esophagogastroduodenoscopy, and bronchoscopy. Traditionally, the insertion tube of an endoscope is advanced by pushing it forward and retracted by pulling it back. The tip of the tube may be directed by twisting and general up/down and left/right movements. Oftentimes, this limited range of motion makes it difficult to negotiate acute angles (e.g., in the recto sigmoid colon), creating patient discomfort and increasing the risk of trauma to surrounding tissues. Laparoscopy involves the placement of trocar ports according to anatomical landmarks. The number of ports usually varies with the intended procedure and number of instruments required to obtain satisfactory tissue mobilization and exposure of the operative field. Although there are many benefits of laparoscopic surgery, e.g., less postoperative pain, early mobilization, and decreased adhesion formation, it is often difficult to achieve optimal retraction of organs and maneuverability of conventional instruments through laparoscopic ports. In some cases, these deficiencies may lead to increased operative time or imprecise placement of components such as staples and sutures. Steerable catheters are also well known for both diagnostic and therapeutic applications. Similar to endoscopes, such catheters include tips that can be directed in generally limited ranges of motion to navigate a patient's vasculature.

There have been many attempts to design endoscopes and catheters with improved steerability. For example, U.S. Pat. No. 3,557,780 to Sato; U.S. Pat. No. 5,271,381 to Ailinger et al.; U.S. Pat. No. 5,916,146 to Alotta et al.; and U.S. Pat. No. 6,270,453 to Sakai describe endoscopic instruments with one or more flexible portions that may be bent by actuation of a single set of wires. The wires are actuated from the proximal end of the instrument by rotating pinions (Sato), manipulating knobs (Ailinger et al.), a steerable arm (Alotta et al.), or by a pulley mechanism (Sato). U.S. Pat. No. 5,916,147 to Boury et al. discloses a steerable catheter having four wires that run within the catheter wall. Each wire terminates at a different part of the catheter. The proximal ends of the wires extend loosely from the catheter so that the physician may pull them. The physician is able to shape and steer the catheter by selectively placing the wires under tension.

Other attempts to design maneuverable instruments include, e.g. robotic systems typically used for minimally invasive surgical procedures. In such systems, the surgeon manipulates master input devices of a computer workstation which controls the motion of a servomechanically operated instrument. Examples include systems such as those described in US 2003/0036748 Al (Cooper et al.). While such computerized systems provide remote maneuverability and control, they require a large capital investment, are expensive to maintain, and typically require a dedicated surgical suite.

Consequently, there is a need for a simple and inexpensive device with enhanced remote maneuverability to controllably navigate complex geometries and allow for more efficient and precise advancement and deployment of instruments and tools. It would also be advantageous for such a device to provide a more intuitive and facile manual user interface to achieve such enhanced maneuverability. Such a device would have widespread application in guiding, steering and/or manipulating instruments and tools across numerous industries. Such a device would also of itself have entertainment, recreation and educational value.

### BRIEF SUMMARY OF THE INVENTION

The present invention provides for devices and link systems incorporated therein that are useful for a variety of purposes including, but not limited to, the remote manipulation of instruments such as surgical or diagnostic instruments or tools. Such surgical or diagnostic instruments or tools include but are not limited to endoscopes, light sources, catheters, Doppler flow meters, microphones, probes, retractors, pacemaker lead placement devices, dissectors, staplers, clamps, graspers, scissors or cutters, ablation or cauterizing elements, and the like. Other instruments or tools in non-surgical applications include but are not limited to graspers, drivers, power tools, welders, magnets, optical lenses and viewers, light sources, electrical tools, audio/visual tools, lasers, monitors, and the like. The types of tools or instruments, methods and locations of attachment, and applications and uses include, but are not limited to, those described in pending and commonly owned U.S. application Ser. Nos. 10/444,769, 10/948,911, 10/928,479, and 10/997,372, each of which is incorporated herein by reference in its entirety. Depending on the application, it is contemplated that devices of the present invention can be readily scaled to accommodate the incorporation of or adaptation to numerous instruments and tools. The link systems and other components may be used to steer these instruments or tools to a desired target site, and can further be employed to actuate or facilitate actuation of such instruments and tools.

In one aspect of the invention, a surgical instrument is provided having a distally located surgical or diagnostic tool, one or more links proximal of the surgical or diagnostic tool, being moveable relative to one another and/or the tool; and a joint assembly proximal of the one or more links, with the joint assembly connected to a manually moveable handle extending proximally of the joint assembly such that manual movement of the handle causes movement of the one or more links. The manual handle can further be operably connected to the distal tool. The links can be operably connected to the joint assembly by cables. In certain variations, two or more cables are distally connected to a link and terminate at the joint assembly, such that manual movement of the handle causes a corresponding movement of the link. In other variations, the instrument can include a plurality of links, with two or more adjacent links being moveable relative to each other. Additional sets of two or more cables can distally connect to an additional link and terminate at the joint assembly.

In further variations of the invention, the surgical instrument also includes an elongate working shaft disposed between the plurality of links and the joint assembly. The shaft aids in advancing the distal tool to a desired location in a patient's body. Depending on the application, the shaft can have varying stiffness of flexibility and be of varying length. In other variations, the joint assembly includes a housing extending from the elongate shaft and a manual actuator connected to the housing by a gimbal. The manual actuator can include an actuator plate, with the cables secured to the actuator plate at varying radial distances from the actuator plate center.

### BRIEF DESCRIPTION OF THE DRAWINGS

FIG. 1 shows a perspective view of a needle driver device according to one embodiment of the invention, with a distal articulating link system, an elongate working shaft, and a proximal joint and handle assembly, with the device in an unbent, unarticulated position;

FIG. 2 shows a top view of the device of FIG. 1;

FIG. 3 shows a perspective view of the device of FIG. 1; in a bent, articulated position;

FIG. 4 shows a top view of the device of FIG. 3;

FIG. 5 shows a reverse angle perspective view of the device of FIG. 3;

FIG. 6 shows a detailed cross-sectional view of the distal end tool and link assembly and the proximal joint and handle assemblies of the device of FIG. 1,. with parts broken away;

FIG. 7 shows a perspective view of the joint assembly of the device of FIG. 1;

FIG. 8 shows a perspective view of the manual actuator component of the joint assembly of FIG. 7;

FIG. 9 shows another perspective view of the manual actuator component of FIG. 8;

FIG. 10 shows a perspective view of the manual actuator component of FIG. 8 connected to a pair of gimbal rings;

FIG. 11 shows a another perspective view of the manual actuator component-gimbal ring assembly of FIG. 10;

FIG. 12 shows enlarged perspective view of the joint assembly of FIG. 7, depicting the manual actuator component-gimbal ring assembly of FIG. 11 connected to the elongate working shaft; and

FIG. 13 shows the perspective view of the joint assembly of FIG. 12, depicting distal link assembly actuating cables connected to the joint assembly.

### DETAILED DESCRIPTION OF THE INVENTION

As further detailed herein, devices according to the present invention include articulating link systems that can form, or be incorporated into, or otherwise constitute, such devices. The link systems may be made from a combination of individual links. Devices according to the invention generally include one or more distal links and at least one set of cables connecting at least one of the links to a proximally located joint assembly. The term “link” as used herein refers to a discrete portion of a link system that is capable of movement relative to another discrete portion of the link system. Links typically but need not have a cylindrical portion. In certain embodiments, the link systems will include a plurality of adjacent links generally aligned along the central axes of each link, when the links are in an unbent, non-articulated position.

Typically each cable set connects an active link to the joint assembly such that movement of the joint assembly causes a corresponding movement of the active link. As used herein, the term “active link” refers to a link that is directly connected to the joint assembly by a cable set. The term “spacer link” refers to a link that is not directly connected by a cable set to the joint assembly. Spacer links can nevertheless be disposed between active links and provide for the passage of cable sets that connect active links. The ability to manipulate active links allows for the device to readily form three-dimensional curves in a given direction as is further detailed herein.

The devices of the present invention may, for example, be used to direct and steer a surgical or diagnostic instrument tool to a target site within a body region of a patient. The device can be introduced from a location outside the patient, either in its native, straight configuration, or after undergoing manipulation at its proximal end. Further, the resulting directional movement of the distal end can be inverted, mirrored, or otherwise moved, relative to the movement of the joint assembly.

In addition to the formation of curves, the present invention also allows for increased rigidity of the device by constraining manipulated active links and allowing such links to resist movement due to laterally applied forces. A given link is considered fully constrained if upon manipulating the joint assembly to achieve the desired shape, and then maintaining the joint assembly in that manipulated condition, the link can resist loads while maintaining its desired, unloaded shape. For links that are otherwise free to move in three degrees of freedom, a minimum of three cables are required to fully constrain the links. This is not always the case with conventional articulating devices. Spacer links will not be so constrained, and the inclusion of such unconstrained links may be advantageous in many situations where it is desirable to have portions of the device be less rigid.

The terms “instrument” and “tool” are herein used interchangeably and refer to devices that are usually handled by a user to accomplish a specific purpose. For purposes of illustration only, link systems and articulating mechanisms of the invention will be described in the context of use for the remote guidance, manipulation, and/or actuation of surgical or diagnostic tools and instruments in remotely accessed regions of the body. As previously noted, other applications of the devices besides surgical or diagnostic applications are also contemplated. Generally, any such application will include any situation where it is desirable to navigate an instrument or tool into a workspace that is not easy to manually navigate by hand or that might otherwise present a risk or danger. These include, without limitation, industrial uses, such as for the navigation of a tool, probe, sensor, etc. into a constricted space, or for precise manipulation of a tool remotely, for the assembly or repair of machinery. The device can also be used to turn e.g. a screw, whether in the straight or bent configuration. These can also include commercial and household situations where the targeted site for the application of a tool or instrument is difficult to access. Other situations can include, e.g., industrial applications where the work environment is dangerous to the user, for example, workspaces exposed to dangerous chemicals. Still other situations can include, e.g., law enforcement or military applications where the user may be at risk, such as deployment of a tool or instrument into a dangerous or hostile location. Yet other uses include recreation or entertainment, such as toys or games, e.g., for remote manipulation of puppets, dolls, figurines, and the like.

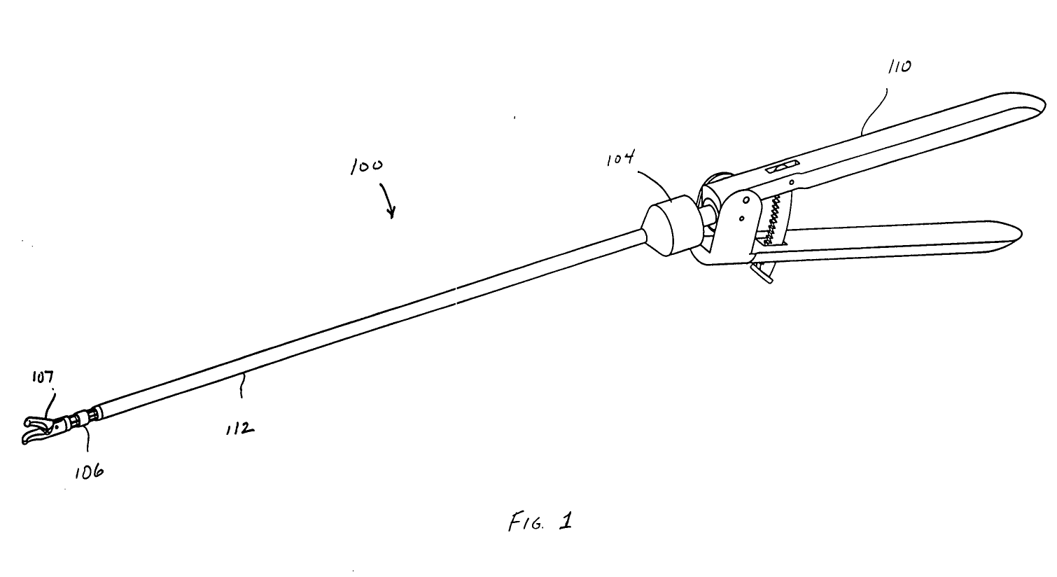

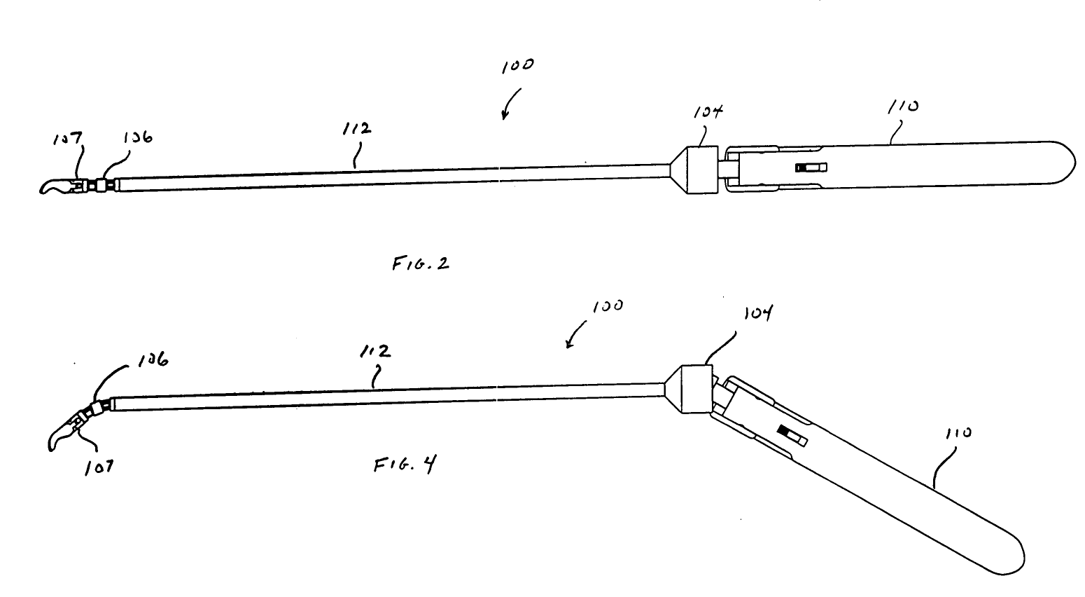

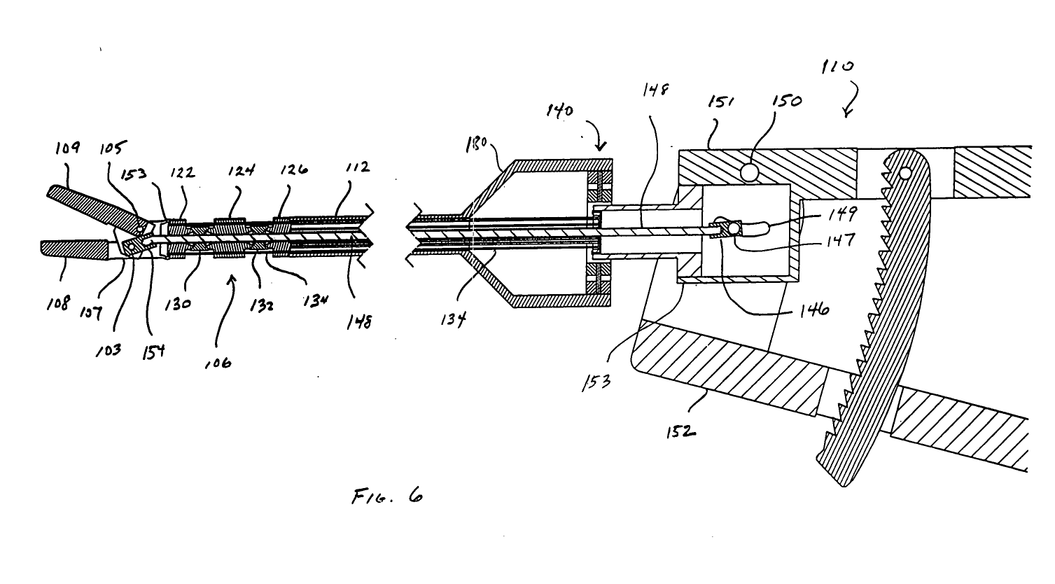

With reference to FIGS. 1-5, an embodiment of the invention is depicted which incorporates articulating link systems and joint assemblies. As shown in FIGS. 1-5, needle driver 100 includes proximal joint assembly 104 and corresponding distal link set 106, separated by elongate shaft 112, which provides a working shaft for advancing the needle driver. Needle driver tool 107 with grasping jaws is attached to the distal end of distal link set 106 and is operationally connected to ratchet handle 110, which is attached to the proximal end of joint assembly 104. Needle driver 100 as configured is suitable for laparoscopic use. While this embodiment incorporates a needle driver tool, it will be readily appreciated that wide variety of surgical tools and instruments can be operationally attached to the distal end, including but not limited to a Doppler flow meter, microphone, endoscope, light source, probe, retractor, dissector, stapler, clamp, grasper, scissors or cutter, or ablation or cauterizing elements, as well as other tools or instruments for non-surgical applications, as has been previously noted.

As depicted in greater detail in FIG. 6, distal link set 106 include links 122, 124, and 126. Distal links (122, 124, and 126) are connected to joint assembly 104, as will be further described herein by sets of cables (134) such that movement of joint assembly 104 causes a corresponding relative movement of distal link set 106. Generally speaking, one or more cables are used to connect a distal end active link to the joint assembly, according to varying embodiments of the invention. As previously noted, each active link is connected to the joint assembly by two or more cables that form a cable set. As noted, movement of an active link is controlled by its corresponding cable set.

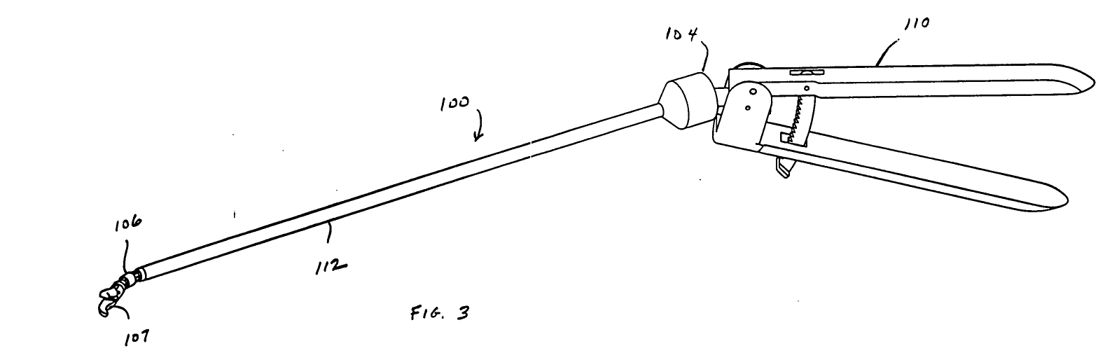

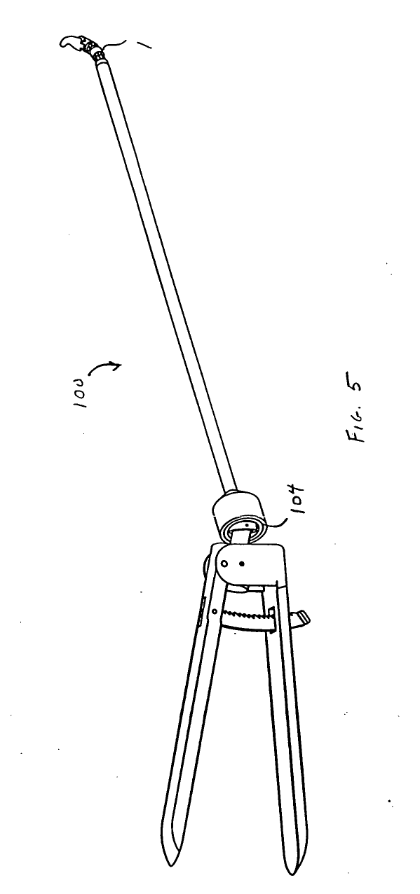

Distal link set 106, as can be seen, includes adjacent links 122 and 124 are separated by a bushing 130, and adjacent links 124 and 126 are separated by a bushing 132. This link-bushing arrangement is as similar to the link-bushing arrangement of link systems disclosed in U.S. application Ser. No. 10/928,479, incorporated herein in its entirety and confers certain advantages described therein. The links further include channels that allow the passage of cable sets. The cable channels are offset from the central axis of the links such that when a tension force is applied to one or more cables, convex protrusions of the links 122, 124, and 126 can rotate within the respective concave depressions of each bushing (130 and 132), thereby pivoting each link about a pivot point and allowing the link set as a whole to bend (FIGS. 3-4). Each link and bushing also includes central channels that are aligned with the central axis of each link or bushing. When assembled, these channels form a central lumen through which an actuating cable (148) is passed for controlling and/or actuating the needle driver tool (107). The central channel generally also provides passage for additional cables, wires, fiberoptics or other like elements associated with any desired tool or instrument used in conjunction with the link system or articulating mechanism of the invention. The central channels of bushings 130 and 132 terminate in the shape of a conical frustum that allows the links and bushings to pivot relative one another without impinging the passage of an actuating cable. The overall dimensions of the conical frustum portion generally will be commensurate with the degree of relative pivoting desired between the links and the bushings. While the provision of a central channel is advantageous for the above reasons, it will be appreciated that links and bushings can also be provided without such channels, and that control of tool or instrument associated with the link system can also be accomplished by routing actuating cables and other like elements along any radial location, including the periphery of the link system.

Device 100 as noted includes elongate shaft 112 disposed between joint assembly 104 and distal link set 106. The shaft is typically hollow and includes lumen 114 that accommodate both the cable sets that connect active links to the joint assembly, as well as actuating cable 148. The shaft lumen generally provides passage for additional cables, wires, fiberoptics or other like elements associated with any desired tool or instrument used in conjunction with the Iink system or articulating mechanism of the invention.

Handle 110 of driver 100 is a conventional ratchet-style handle that is operably linked to actuating cable 148. In particular, as shown in FIG. 6, handle 110 includes fixed arm 151 and pivoting arm 152, with arm 151 secured to joint assembly 104 by collar 153 which engages joint assembly 140 as further entailed herein. Pivoting arm 152 is pivotally connected to fixed arm 151 at pivot 150, and further includes pin 147, which is received and translatable in guide slot. 149 of arm 151. Actuating cable 148 terminates at it proximal end at the distal end of cable connector 146 which further receives pin 147 at its proximal end. When the handle 110 is actuated, arm 152 pivots around pivot point 150, thereby causing translational movement (i.e., retraction) of the cable connector 146 and actuating cable 148 toward the proximal end of the device.

Needle driver 107 is similarly secured to distal link 122 by collar 153 which engages reciprocal hub portion 121 of link 122. Jaws 108 and 109 extend distally with jaw 108 fixed and jaw 109 pivotally connected to jaw 108 at pivot 105. Cable connector 154 attaches to jaw 108 at its distal end at pin 103, and the distal end of actuating cable 148 is secured to the proximal end of cable connector 154. A spring (not shown) can be disposed around cable 148 and between cable connector 154 and distal link 122, to keep the cable in tension and jaw 109 in the open position. The needle driver is actuated by retraction of the central cable 148, which retracts connector 154 and compresses spring 156, causing pivotal movement of jaw 109 about pivot 105 into a closed position against jaw 108.

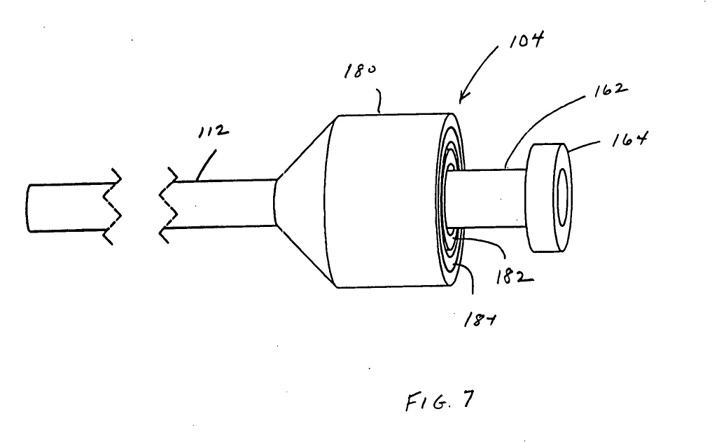

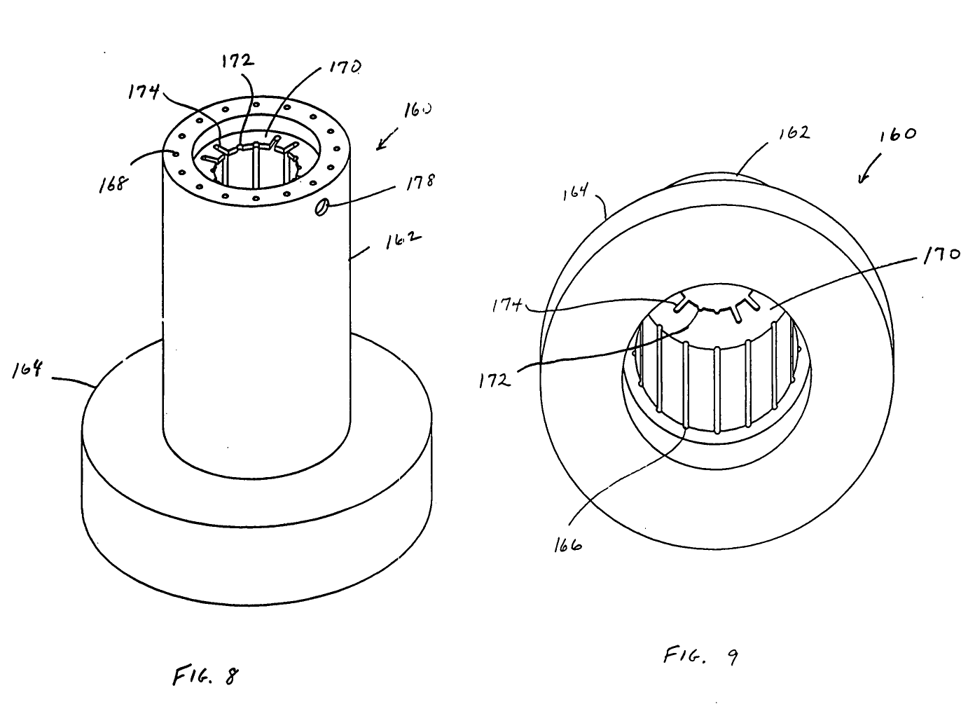

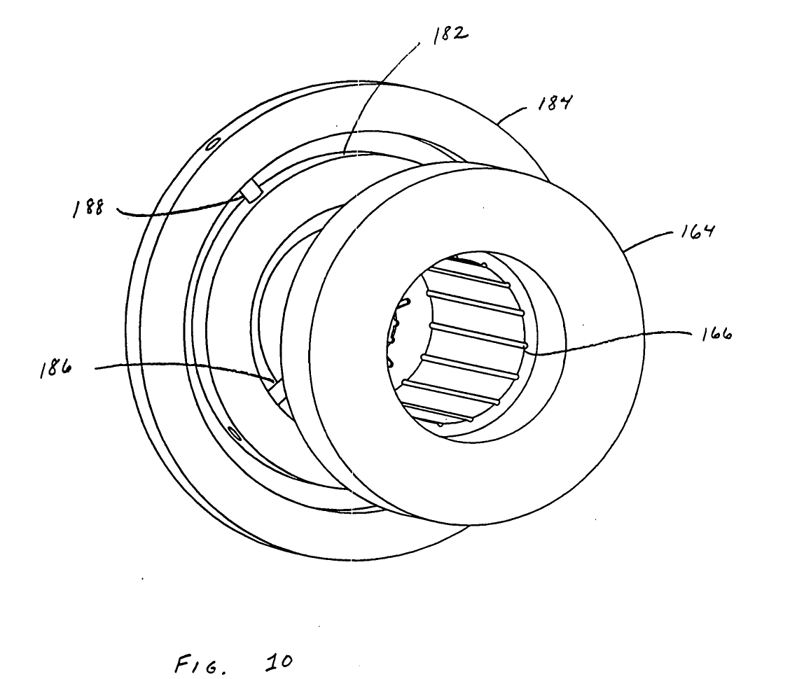

FIGS. 7-13 show joint assembly 104 and its components in greater detail. As further detailed herein, joint assembly 104 includes housing 180 which extends from working shaft 112 and manual actuator 160, which is connected to housing 180 through gimbal rings 182, 184. As seen more clearly in FIGS. 8-9, manual actuator is formed of hollow shaft 162 that terminates at its proximal end in hub 164. Hub 164 is configured for receipt and securement to collar 163 of handle 110. The handle can be attached to the collar in a variety of ways known in the art, including e.g. the use of mechanical fasteners, such as screws, or by press or interference fit, or by bonding, brazing, welding, laser welding, and the like. Actuator plate 170 spans the distal end of shaft 162. As can be seen, actuator plate 170 includes a central aperture that allows passage of actuating cable 148. Actuator plate further includes an arrangement of inner and outer slots 172 and 174, with outer slots 174 extending radially further from the center of the actuator plate than inner slots 172, similar to the actuator plate of the pivoted plate cable actuator mechanism disclosed in US 2003/0036748 A1, incorporated herein in its entirety. Cable channels 168 extend through the shaft wall and actuator plate and are in communication with grooves 166 which are merely extensions of channels 168 extending lengthwise along the interior of the shaft. Each channel is aligned with one of slots 172, 174. Actuating cables that connect to distal link set 106 are attached to the actuator plate as further described herein. Shaft 162 can be of any length as long as it provides for adequate clearance of attached handle 110 as it is moved relative to housing 180.

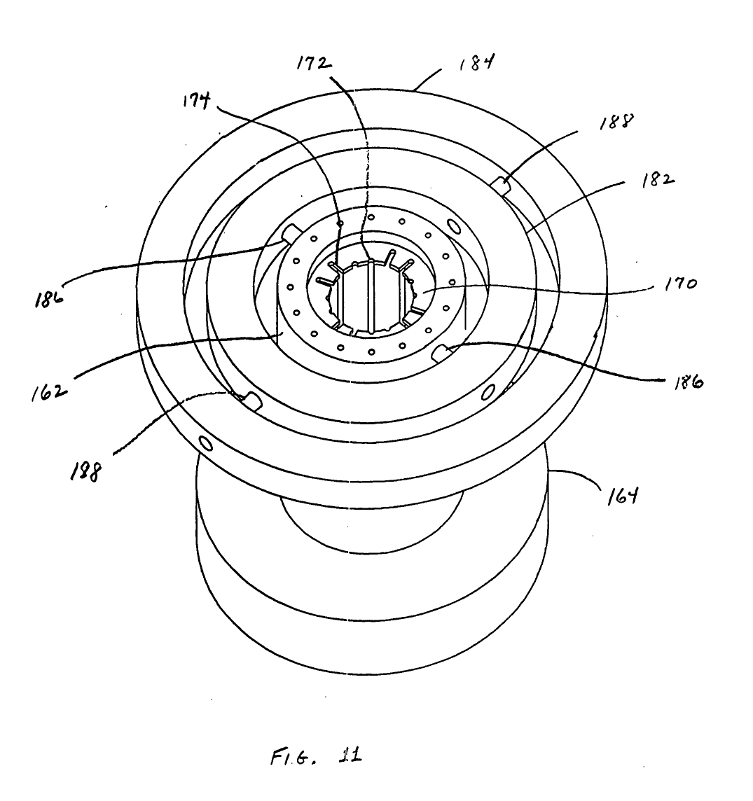

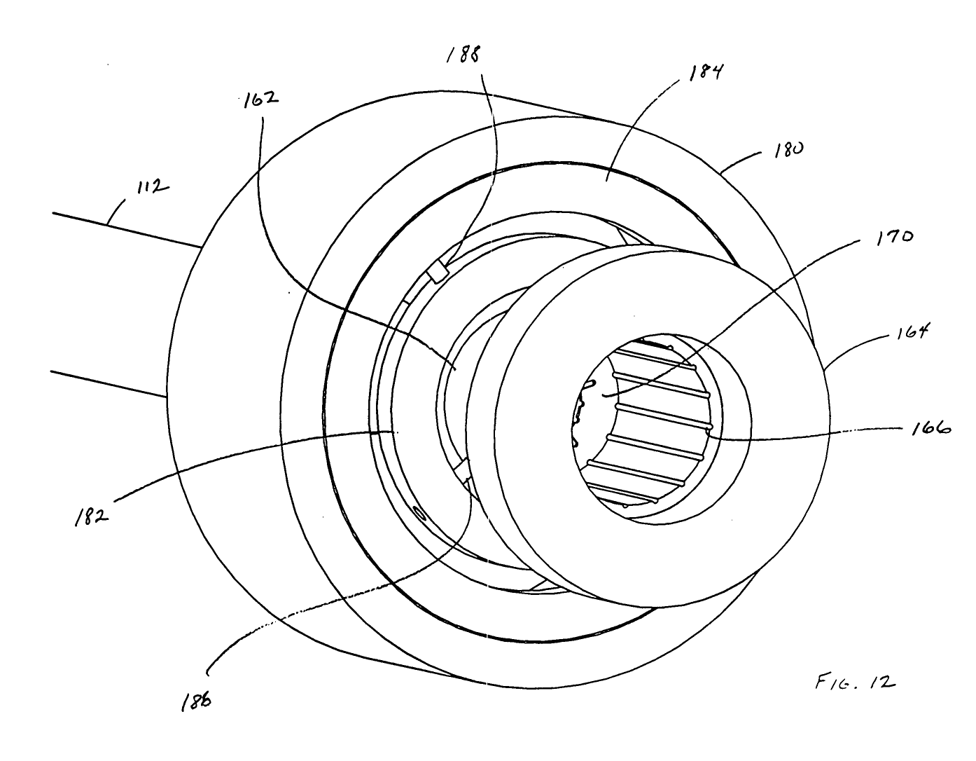

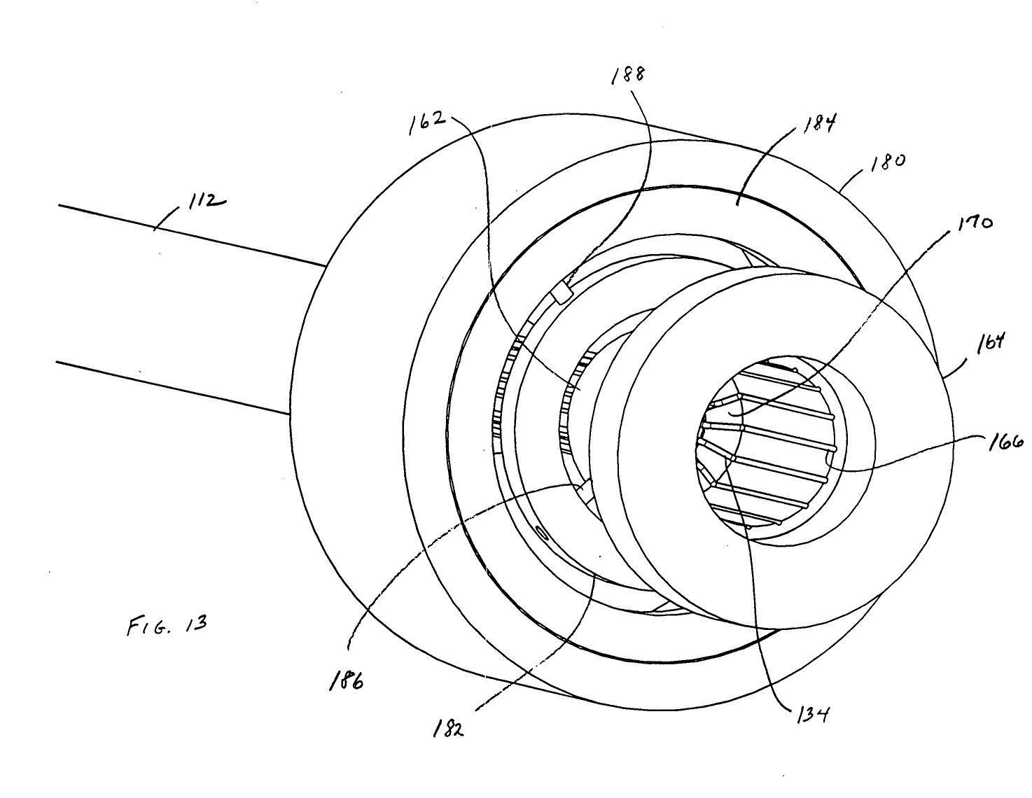

Turning to FIGS. 10-11, it can be seen that manual actuator 160 is connected to concentric gimbal rings 182 and 184 at a location adjacent the actuator plate. Specifically, shaft 162 is pivotally mounted to inner gimbal ring 182 by pivots 186, and outer gimbal ring 184 is pivotally mounted to inner gimbal ring 182 by pivots 188, such that actuator 160 can freely move in both pitch and yaw axes. As seen more clearly in FIG. 12, outer gimbal ring 184 is secured to housing 180, and thus actuator 160 can move in pitch and yaw relative to the housing 180. The outer gimbal ring can be mounted to the housing in a variety of ways known in the art, including e.g. the use of mechanical fasteners, such as screws, or by press or interference fit, or by bonding, brazing, welding, laser welding, and the like.

As seen in FIG. 13, the actuating cables 134 that connect links of link set 106 to the joint assembly are received proximally through working shaft 112 and pass through the actuator plate aperture, where they are received in slots 172, 174, then directed radially outward, and secured in the corresponding cable channels 168. In order to properly coordinate bending of distal link set 106, as is depicted in FIGS. 3-5, the cables that are associated with the most distal link 122 are secured in outer slots 174 while the cables associated with inner link 124 are secured in inner slots 172. Cables secured in outer slots 174 are at a greater radial distance from the center axis of shaft 112 relative to cables secured in inner slots 172, and thus will experience a greater range of motion relative to the center axis than cables secured in inner slots 172 when the manual actuator of the joint assembly is manipulated. This results in a corresponding greater degree of movement and deflection of distal link 122 relative to link 124 at the distal link set, thereby achieving a smooth, coordinated bending of distal link set 106. Further while the depicted embodiment involves radial slots of varying dimensions, it will be appreciated that there a variety of other ways to secure cables to the actuator plate at differing radial locations to accomplish the same function.

Consistent with the configurations and parameters presented above, the devices of the invention and the link systems incorporated therein may be of any size and shape, as the purpose dictates. For surgical applications, their form usually depends on such factors as patient age, anatomy of the region of interest, intended application, and surgeon preference. As noted, the outer circumferences of links are generally cylindrical, and may include channels for passage of the cables that connect links to other links or components of the device, as well as additional cables, wires, fiber optics or other like elements associated with a desired tool or instrument used in conjunction with the device. The channel diameters are usually slightly larger than the cable diameters, creating a slip fit. Further, the links may also include one or more channels for receiving elements of attachable surgical instruments or diagnostic tools or for passage of additional cables that actuate them. As noted, such channels can be located along the center or the periphery of the links. The links may typically have a diameter from about 0.5 mm to about 15 mm or more depending on the application. For endoscopic and laparoscopic applications, representative link diameters may range from about 2 mm to about 3 mm for small endoscopic and laparoscopic instruments, about 5 mm to about 7 mm for mid-sized endoscopic and laparoscopic instruments, and about 10 mm to about 15 mm for large endoscopic and laparoscopic instruments. For catheter applications, the diameter may range from about 1 mm to about 5 mm. The overall length of the links will vary, usually depending on the bend radius desired between links.

For surgical applications, the links or other components of the device may be made from any biocompatible material, including, but not limited to: stainless steel; titanium; tantalum; and any of their alloys; and polymers, e.g., polyethylene or copolymers thereof, polyethylene terephthalate or copolymers thereof, nylon, silicone, polyurethanes, fluoropolymers, poly (vinyl chloride), acrylonitrile-butadiene-styrene (ABS) terpolymer, polycarbonate, Delrin and Delrin substitutes (i.e. acetal homopolymers), combinations thereof, and other suitable materials known in the art. A lubricious coating may be placed on the links or other components of the device if desired to facilitate advancement of the device. The lubricious coating may include hydrophilic polymers such as polyvinylpyrrolidone, fluoropolymers such as tetrafluoroethylene, or silicones. A radio opaque marker may also be included on one or more links or elsewhere on the device to indicate the location of the device upon radiographic imaging. Usually, the marker will be detected by fluoroscopy.

The joint assembly may likewise be formed from a variety of materials, including SST. Other suitable materials include e.g. titanium, aluminum, engineering plastics like PEEK, Radel®, or other suitable materials known in the art. Suitable handle materials include SST, titanium, aluminum, polycarbonate, ABS or other suitable materials known in the art. The handle can also be provided in a variety of styles, depending on the intended applications, and can include palm grip, pistol grip, and ring-tipped style handles, as well as other handle style known in the arts.

Although the distal link set that has been illustrated in the accompanying figures has a certain number of links, this is solely for the illustrative purpose of indicating the relationship of the individual link components to one another. Any number of links may be employed, depending on such factors as the intended use and desired length and range of movement of the device.

As noted, cables connected the joint assembly may be used to actuate the link systems. Each cable set may be made up of at least two cables. In certain variations, for example, a cable set will include three cables. By using a set of three cables to connect to a link, the link can be manipulated or moved in three degrees of freedom (i.e., up/down motion, left/right motion, and rotational or “rolling” motion, or pitch, yaw, roll movement) independently of any other links.

Cable diameters vary according to the application and may range from about 0.15 mm to about 3 mm. For catheter applications, a representative diameter may range from about 0.15 mm to about 0.75 mm. For endoscopic and laparoscopic applications, a representative diameter may range from about 0.5 mm to about 3 mm.

Cable flexibility may be varied, for instance, by the type and weave of cable materials or by physical or chemical treatments. Usually, cable stiffness or flexibility will be modified according to that required by the intended application of the device. The cables may be individual or multi-stranded wires made from material, including, but not limited to, biocompatible materials such as nickel-titanium alloy; stainless steel or any of its alloys; super elastic alloys; carbon fibers; polymers, e.g., poly (vinyl chloride), polyoxyethylene, polyethylene terephthalate and other polyesters, polyolefin, polypropylene, and copolymers thereof, nylon; silk; and combinations thereof, or other suitable materials known in the art.

The cables may be affixed to the links according to ways known in the art, such as by using an adhesive or by brazing, gluing, soldering, welding, ultra-sonically welding, screwing, and the like, including methods described in pending and commonly U.S. application Ser. No. 10/444,769, 10/948,911, and 10/928,479, each of which is incorporated herein by reference in its entirety.

Spacer links, i.e., links not connected to the joint assembly by discrete sets of cables, may also be included in the devices of the invention. These links act as passive links that are not independently actuatable, but do allow for pass through of cable sets to neighboring active links. Spacer links can be desirable for providing additional length in a link system.

The links and/or bushings described herein also may be configured to have positive, negative, or neutral cable bias, as described in U.S. patent application Ser. Nos. 10/444,769, 10/948,911, and 10/928,479, each of which is incorporated herein by reference in its entirety.

The devices may also include a locking mechanism. When activated, the locking mechanism prevents one or more links or pairs of links from moving as described in U.S. patent application Ser. Nos. 10/444,769, 10/948,911, and 10/928,479, each of which is incorporated herein by reference in its entirety. The devices disclosed herein can incorporate any aspects of any other devices disclosed in U.S. patent application Ser. Nos. 10/444,769, 10/948,911, and 10/928,479, including but not limited to steerable catheters, endoscopes, and hand-actuated devices.

The invention also contemplates kits for providing various devices and associated accessories. For example, kits containing devices having different lengths, different link diameters, and/or different types of tools or instruments may be provided. The kits may optionally include different types of pre-assembled locking mechanisms. The kits may be further tailored for specific applications. For example, kits for surgical applications can be configured for, e.g., endoscopy, retraction, or catheter placement, and/or for particular patient populations, e.g., pediatric or adult.

All publications, patents, and patent applications cited herein are hereby incorporated by reference in their entirety for all purposes to the same extent as if each individual publication, patent, or patent application were specifically and individually indicated to be so incorporated by reference. Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit and scope of the appended claims. Applicants have not abandoned or dedicated to the public any unclaimed subject matter.

We claim:

1. A surgical instrument comprising:
a surgical or diagnostic tool;
a plurality of links proximal of the surgical or diagnostic tool, wherein at least two or more adjacent links are moveable relative to one another; and
a joint assembly proximal of the plurality of links, the joint assembly connected to a manually moveable handle extending proximally of the joint assembly such that manual movement of the handle causes movement of the two or more adjacent links.

2. The surgical instrument of claim 1 further comprising two or more cables distally connected to at least one of the two or more adjacent links and terminating at the joint assembly.

3. The surgical instrument of claim 1 further comprising an elongate shaft disposed between the plurality of links and the joint assembly.

4. The surgical instrument of claim 3 wherein the joint assembly includes a housing extending from the elongate shaft and a manual actuator connected to the housing by a gimbal and wherein the handle extends proximally from the manual actuator.

5. The surgical instrument of claim 4 wherein the manual actuator includes an actuator plate and wherein the cables are secured to the actuator plate at varying radial distances from the actuator plate center.

6. The surgical instrument of claim 1 wherein the handle is operably connected to the distal tool.

7. The surgical instrument of claim 1 further comprising a locking mechanism that when actuated impedes movement of the links.

8. A manual joint-handle assembly for remotely maneuvering a distally located tool, the assembly comprising:
a joint assembly connected to a manually moveable handle extending proximally of the joint assembly, the joint assembly being connectable to the distally located tool and wherein manual movement of the handle causes movement of the joint assembly that is translatable to the distally located tool when connected to the joint assembly.

9. The manual joint-handle assembly of claim 8 wherein the joint assembly includes a housing and a manual actuator connected to the housing by a gimbal and wherein the handle extends proximally from the manual actuator.

10. The manual joint-handle assembly of claims 8 or 9 wherein the manual actuator includes an actuator plate configured to secure actuating cables to the actuator plate at varying radial distances from the actuator plate center.
